(19) United States
(12) Patent Application Publication
(10) Pub. No.: US 2008/0144011 A1
(43) Pub. Date: Jun. 19, 2008

(54) Apparatus and Method for Detecting the Orientation/Position of Products, in Particular Fish, on a Transport Element

(76) Inventors: Arne Burmeister, Oststeinbek (DE); Alexander Rieker, Neuengors (DE)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/815,921

(22) PCT Filed: Jan. 26, 2006
(86) PCT No.: PCT/EP2006/000855

§ 371 Date: Aug. 9, 2007

(30) Foreign Application Priority Data
Feb. 11, 2005 (DE) 10 2005 007 150.3

(51) Int. Cl. G01N 21/00

(52) U.S. Cl. 356/73

(57) ABSTRACT

The invention relates to an apparatus for detecting the orientation/position of products, in particular fish on a transport element. Said apparatus includes a transport element for transporting the products from an input area to an output area and measuring means arranged in the region of the transport element. The apparatus is characterised in that the measuring means comprises a support, on which at least two transmitters and at least two receivers are positioned. The invention also relates to a corresponding method.

The invention concerns an apparatus for detecting the orientation/position of products, in particular fish, on a transport element, including a transport element for transporting the products from an input area to an output area and a measuring means arranged in the region of the transport element. Furthermore, the invention concerns a method for detecting the orientation/position of products, in particular fish, on a transport element, including the steps of: transporting the products on a transport element from an input area to an output area, determining the orientation/position of the products by a measuring means during transport of the products on the transport element.

Apparatuses and methods of this kind are used whenever the orientation or position of the products is important for subsequent treatment/processing. In the fish-processing industry the position of a fish, that is, transport of the fish head or tail first, and/or the position or orientation of the belly and back, is, for example, of particular importance for subsequent processing.

The known apparatuses and methods use, amongst other things, image data, by means of which analysis the orientation/position of the products or fish is determined. How-ever, this is, on the one hand, very elaborate in design, because high-power cameras with corresponding equipment are necessary. On the other hand, the performance of such an apparatus is limited because the speed of transport must be low at the time of image data collection. Other known apparatuses and methods determine the belly/back position only if the products/fish are measured transversely to their longitudinal extent. Such measuring methods are not only very expensive, but also cannot be transferred to measurement in the longitudinal direction of the products/fish.

It is therefore the object of the present invention to provide a simple and compact apparatus for reliable detection of the orientation/position of products. Furthermore, it is the object of the invention to propose a simple and reliable method for detection of the orientation/position of products.

This object is achieved firstly by an apparatus with the features mentioned hereinbefore by the fact that the measuring means includes a support on which are arranged at least two transmitters and at least two receivers. This firstly ensures a simple construction of the apparatus. Furthermore, the arrangement of several transmitters and two receivers ensures that several measured values are determined and can be evaluated by calculating the difference, so that as a result there is a clear and reliable allocation of the orientation/position of the products.

Preferably, the support is of arcuate design and spans the transport element, describing a semicircle. This ensures that each product can be automatically detected by the measuring means independently of its position and orientation. Also, due to the uniform light distribution, measurement can be carried out independently of the shape of a product because e.g. different curvatures of the product are equalised. Another advantage of the above arrangement or construction lies in the compact and simple design of the apparatus.

In a preferred development of the invention, the transmitters are designed as light-emitting diodes and the receivers as photometers. Due to the design of the measuring means as an arc, uniform illumination of the product is achieved, leading to reliable detection. Furthermore, this ensures a very high speed of transport of the products on the transport element. In spite of the high speed, the claimed design of the transmitters and receivers allows reliable reception of the measured values.

Advantageously, the transmitters and receivers are directed onto the centre of the circle. As a result, the orientation/position of the products can be determined independently of their size. To put it another way, nearly all species and sizes of fish can be defined with respect to their orientation/position.

Furthermore, the object is achieved by a method with the steps mentioned hereinbefore by the fact that, for determining the orientation/position, the products are subjected to transmitter signals and the corresponding reflections are received at least two points.

By this method, it is possible in a particularly simple and reliable manner to ensure determination of the orientation/position of the products.

Preferably, the different reflection properties of ventral side and dorsal side of a product/fish on the one hand and of head region and tail region on the other hand are evaluated for detection of the orientation/position of the product/fish on the transport element. To put it another way, the characteristics naturally inherent in any product/fish are used for evaluation. In the products/fish, the back is usually darker than the belly. The head region shows higher reflection than the tail region. From this measured information a statement about the orientation/position of the fish can be reliably obtained.

Further advantageous and preferred features and embodiments as well as steps of the method are apparent from the subsidiary claims and the description. A particularly preferred embodiment as well as the principle of the method are described in more detail with the aid of the attached drawings. The drawings show:

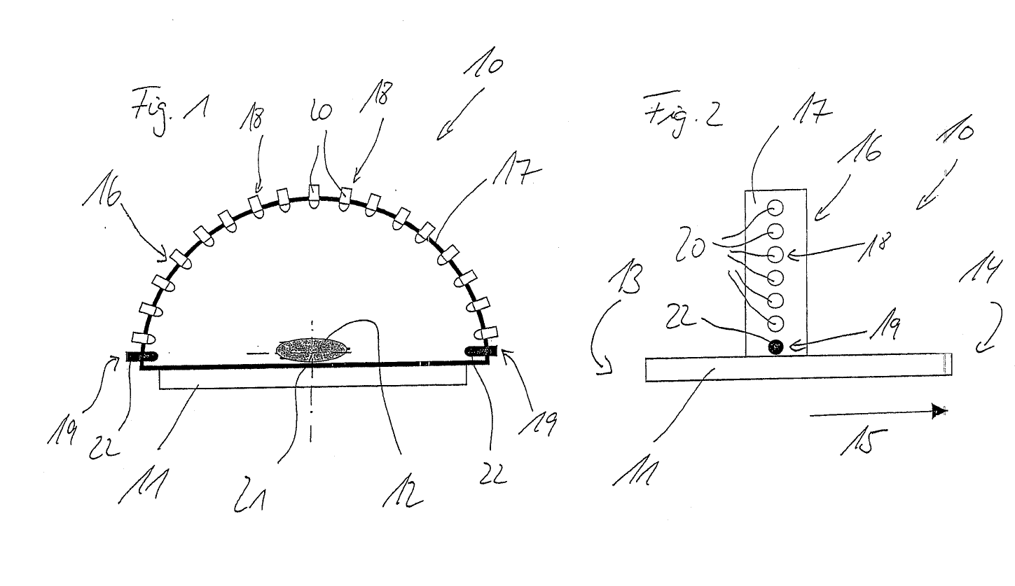

FIG. 1 a front view (view in the direction of transport) of an apparatus according to the invention, and

FIG. 2 a side view of the device according to FIG. 1.

The apparatus shown and the method described below are used for detection of the orientation/position, that is, head first or tail first, and the belly/back position, of fish transported in their longitudinal direction. However, the invention is not confined to this field of application. The apparatus and the method can also be used to detect the orientation/position of other products which have different reflection properties.

The apparatus 10 shown in FIGS. 1 and 2 includes a transport element 11 which can be designed as a conveyor belt or in some other usual way. By means of the transport element 11 products, for example the fish 12, can be transported from an input area 13 to an output area 14. In the input area 13 can be arranged e.g. a first apparatus (not shown) for treatment/processing of the fish, or also only a reservoir of fish 12. The fish 12 can also be directly moved onto the transport element 11 automatically or manually e.g. by an operator. In the output area 14 can be arranged further apparatuses (not shown) for further processing of the fish 12. The fish 12 can be transported optionally continuously or cyclically from the input area 13 to the output area 14 in the direction of conveying (in the direction of arrow 15).

Furthermore, the apparatus 10 includes a measuring means 16 which is associated with the transport element 11. The measuring means 16 is a kind of arc which includes a support 17 having transmitters 18 and receivers 19 arranged thereon. The support 17 is arcuate and describes a semicircle. The support 17 is fixed in the region of the transport element 11 and spans the latter in such a way that all the fish 12 being transported on the transport element 11 are conveyed through below the support 17. Alternatively, however, other forms of the support 17 can be used as well. It can be constructed in one or more parts. It is important that, from both sides of the transport element 11, transmitters 18 and receivers 19 can be directed onto the transport element 11 for uniform impingement of signals and reception thereof.

The transmitters 18 are designed as light-emitting diodes 20. However, any other kind of light- or radiation-emitting transmitter 18 can be used likewise. At least two, but preferably more light-emitting diodes 20 are evenly distributed over the (partial) circumference of the support 17. All of the light-emitting diodes 20, which are arranged for example at a radius of 250 mm (other radii are of course possible) over the transport element 11, have an orientation such that the light rays are directed onto the centre 21 of the circle. The same applies to the receivers 19 which are designed as photometers 22. The photometers 22 (two photometers 22 are sufficient, but there can be more on both sides of the products or of the transport element 11) are arranged on mutually opposed sides of the transport element 11 (to the right and left of the transport element 11 in the direction of transport according to arrow 15). They are positioned in the region of the free ends of the support 17, this being in such a way that they are arranged just above the plane of transport spanned by the transport element 11 and directed essentially parallel to the plane of transport.

At least the receivers 19, that is, the photometers 22, are connected to an evaluating unit, not shown. The latter can be e.g. PC-assisted. Optionally the transmitters 18, that is, the light-emitting diodes 20, can also be connected to the evaluating unit and/or a separate control system. According to the result of evaluation, behind the apparatus 10 can be arranged e.g. an apparatus for turning and/or rotating the products in order to move the products/fish 12 to the desired orientation/position.

Below, the principle of the method is described in more detail with the aid of the figures. The fish 12 are laid manually or automatically on the transport element 11, this being with their longitudinal extent in the direction of transport according to arrow 15. The fish 12 are usually transported continuously on their sides from the input area 13 to the output area 14, passing the measuring means 16. To be more precise, the fish 12 are conveyed through under the support 17. By the light-emitting diodes 20 on the support 17, the fish 12 are uniformly subjected to light signals or light rays. When a fish 12 passes through the light arc, the back which is darker than the belly absorbs at least a substantial proportion of the light rays, so that the photometer 22 which faces towards the back detects a small quantity of light. The lighter, frequently silvery belly of the fish 12 reflects the light of the light-emitting diodes 20, so that the photometer 22 facing towards the belly detects a greater quantity of light. By means of the evaluating unit the position of the belly/back can be determined e.g. by calculating the difference. To increase the reliability, the reflected light rays can also be picked up at several points.

Due to the fact that the fish can be scanned, so to speak, during transport through below the light arc, the head/tail position can also be determined. It has been shown that the head region shows higher light reflection than the tail region. By matching the data first picked up when the fish 12 enters under the light arc and the data last picked up when it emerges from the light arc, the orientation with respect to head or tail, that is, head first or tail first, can be determined exactly.

The measuring method described is independent of the shape of the fish 12, as different shapes, in particular curvatures, of the fish 12 are equalised by the uniform light of the light arc. Also, the measuring method is independent of size due to orientation of the light-emitting diodes 20 and the photometers 22 onto the centre 21 of the circle or, to be more precise, onto the centre of the fish.

1. Apparatus for detecting the orientation/position of products, in particular fish, on a transport element, including a transport element for transporting the products from an input area to an output area as well as a measuring means arranged in the region of the transport element, characterised in that the measuring means includes a support on which are arranged at least two transmitters and at least two receivers.

2. Apparatus according to claim 1, characterised in that the support is of arcuate design and spans the transport element, describing a semicircle.

3. Apparatus according to claim 1, characterised in that the transmitters are designed as light-emitting diodes and the receivers as photometers.

4. Apparatus according to claim 3, characterised in that the light-emitting diodes are evenly distributed over the circumference of the support.

5. Apparatus according to claim 3, characterised in that the light-emitting diodes are directed onto the centre of the circle of the support.

6. Apparatus according to claim 3, characterised in that the two photometers are arranged at the ends of the support.

7. Apparatus according to claim 6, characterised in that the photometers are arranged on mutually opposed sides of the transport element just above the plane of transport spanned by the transport element.

8. Apparatus to claim 3, characterised in that the photometers are essentially directed onto the centre of the circle of the support.

9. Apparatus according to claim 1, characterised in that at least the receivers are connected to an evaluating unit.

10. Method for detecting the orientation/position of products, in particular fish, on a transport element, including the steps of:
transporting the products on a transport element from an input area to an output area,
determining the orientation/position of the products by a measuring means during transport of the products on the transport element,
characterised in that, for determining the orientation/position, the products are subjected to transmitter signals and the corresponding reflections are received at least two points.

11. Method according to claim 10, characterised in that the products are transported through on their sides in their longitudinal extent in the direction of transport under the measuring means, the products being uniformly irradiated with light.

12. Method according to claim 11, characterised in that the products are irradiated in a semicircle by means of light-emitting diodes, all the light rays being directed onto the centre of the circle of a support for the measuring means.

13. Method according to claim 11, characterised in that the reflections of the transmitted signals emitted by the products are received at mutually opposed points of the transport element by means of photometers the difference in the received signals being evaluated to determine the orientation/position.

14. Method according to claim 10, characterised in that the different reflection properties of ventral side and dorsal side of a fish on the one hand and of head region and tail region on the other hand are evaluated for detection of the orientation/position of the fish on the transport element.
